(19) United States
(12) Patent Application Publication
(10) Pub. No.: US 2015/0047418 A1
(43) Pub. Date: Feb. 19, 2015

(54) DETERMINATION OF PORE STRUCTURE CHARACTERISTICS OF ABSORBENT MATERIALS UNDER COMPRESSION

(71) Applicants: Krishna Gupta, Ithaca, NY (US); Akshaya Jena, Ithaca, NY (US)

(72) Inventors: Krishna Gupta, Ithaca, NY (US); Akshaya Jena, Ithaca, NY (US)

(73) Assignee: POROUS MATERIALS, INC., Ithaca, NY (US)

(21) Appl. No.: 14/180,202

(22) Filed: Feb. 13, 2014

Related U.S. Application Data
(63) Continuation of application No. PCT/US13/25803, filed on Feb. 13, 2013.

(51) Int. Cl. G01N 15/08; G01N 3/08

(52) U.S. Cl. CPC G01N 15/088; G01N 3/08
USPC 73/38

(57) ABSTRACT

Compression testing apparatus for analyzing porous materials includes a cylindrical channel having a central bore, solid outside, upper and lower walls, the inner edge of the channel being open to the inner bore. A flexible sealing member having a central bore concentric to the bore of the cylindrical channel opposes the edge of the channel. The flexible walls of the flexible member overlap with and are sealingly affixed to the upper and lower surfaces of the channel. The central bore of the flexible sealing member thus forms a sample chamber for porous material to be tested. Top and bottom sealing members cover the sample chamber and a gas inlet enters through the outside wall of the cylindrical channel for applying biaxial or radial compression on the test material. Triaxial compression is applied with addition of a weight or piston sealingly engaged within the central bore of the flexible sealing member.

### REFERENCE TO RELATED APPLICATIONS

This application claims an invention, which was disclosed in Provisional Application No. 61/598,275, filed Feb. 13, 2012, entitled “MEASUREMENT OF PORE SIZE, PORE VOLUME AND PERMEABILITY OF NONWOVENS UNDER BIAXIAL, TRIAXIAL, AND UNIAXIAL COMPRESSION”. The benefit under 35 U.S.C. §119(e) of the United States Provisional Application is hereby claimed, and the complete disclosure of the aforementioned application is hereby incorporated herein by reference in its entirety.

### BACKGROUND OF THE INVENTION

1. Field of the Invention

The invention pertains to the field of pore structure characterization. More particularly, the invention pertains to methods and apparatus for determination of the pore size, pore volume and permeability of porous materials under compression.

2. Description of Related Art

Various porous materials currently are being developed and used for applications in a wide variety of industries, including, for example, fuel cells, biotechnology, filtration, and the household, hygienic and apparel industries, to name but a few. Many of these porous materials are non-woven materials, which are widely used for a variety of applications including feminine hygiene, baby care, wipes, tissue, patches, bandages, drug delivery, shoes, and many more. In all such applications, the product's ability to take in liquid and give up liquid are of paramount importance. Many of the components of such products have the ability to swell and absorb liquids many times more than their volume.

Many applications of such materials often require the materials to operate under confined pressure. For example, a baby sitting on a diaper subjects the diaper to uniaxial compression. Similarly, tampons tend to swell during use and are thus subjected to biaxial compression. The performance of such products is governed by their pore structure characteristics. Characteristics such as pore diameter, pore size distribution, pore volume and liquid permeability determine the ability of the material to absorb liquids and/or drain liquids. These characteristics also control the rate of absorption or drainage. Furthermore, the pore structure and performance can change considerably, due to swelling and the presence of compressive stress, and the nature of the stress also can change the performance considerably.

Therefore, the influence of compressive stress on the pore structure characteristics of porous materials often is required to evaluate the suitability of the materials for various applications. Thus, there is a strong need in the art for the development of suitable technology to measure the pore structure characteristics of non-woven absorbent materials, particularly while such materials are subjected to compressive stress. More particularly, pore structure characteristics in the x-y plane determine the performance of a number of materials in application. For example, in materials used in the manufacture of diapers, in-plane permeability and liquid intakes are very important. Hence, for product development, performance evaluation and/or quality control, for example, often it is important to be able to measure the pore structure characteristics of such porous materials under simulated environments that include the controlled application of compressive stress.

Pore structure characteristics, such as, for example, the pore diameter, pore distribution, pore volume and permeability of many porous materials can be measured by wetting liquid extrusion techniques. These techniques are based on the simple principle that a wetting liquid spontaneously fills the pores of a porous material. For the wetting liquid, the surface free energy of the filtration media with the liquid is less than the surface free energy of the filtration media with air. Therefore, filling of the pores by the wetting liquid is accompanied by a decrease in free energy and the filling process is spontaneous. The wetting liquid cannot spontaneously flow out of the pores, however, it can be removed from the pores by a pressurized non-reacting gas.

The gas pressure needed to displace a wetting liquid from a pore is related to the pore diameter in accordance with equation 1, as follows:

p=4γ cos θ/D (1)

where, p is the differential gas pressure on the wetting liquid in the pore, γ is the surface tension of the wetting liquid, θ is the contact angle of the wetting liquid with the sample, and D is the pore diameter. Two different techniques are based on this principle: capillary flow porometry and liquid extrusion porosimetry.

CAPILLARY FLOW POROMETRY—The pore structure characteristics of many porous materials can be measured accurately in the Capillary Flow Porometer of Porous Materials, Inc. (See Akshaya Jena and Krishna Gupta, Characterization of Pore Structure of Filtration Media, Fluid/Particle Separation Journal, Vol. 14, No. 3, 2002, pp. 227-241, the complete disclosure of which is hereby incorporated herein by reference in its entirety). Porous Materials, Inc. is a pioneer in the field of flow porometry and has obtained several patents in the field, including U.S. Pat. No. 6,766,257, which describes capillary flow porometry, the complete disclosure of which is hereby incorporated herein by reference in its entirety.

In the technique of capillary flow porometry, the differential gas pressure and flow rates are measured. Differential gas pressure and flow rates are also measured in the completely dry condition. From these measurements pore diameter, pore distribution, the largest pore diameter, and mean flow pore diameter are obtained. With suitable attachments, liquid permeability also can be measured. FIG. 1 shows a sample chamber for a capillary flow porometer.

U.S. Pat. No. 6,766,257 discloses apparatus and methods for capillary flow porometry. The PMI Capillary Flow Porometer is a completely automated instrument. It measures pressures of the test gas accurately. It increases pressure in small increments, allows the system to equilibrate, and then records the increase in pressure. The flow rate through the sample is also measured accurately. Pressures can be raised to high values or reduced from high values to very low values. The porometer delivers the compressed gas through a tube to the sample chamber, which can be designed to hold samples of various sizes and shapes.

LIQUID EXTRUSION POROSIMETRY—The pore structure characteristics of many porous materials can be measured accurately in the Liquid Extrusion Porosimeter of Porous Materials, Inc. (See Akshaya Jena and Krishna Gupta, Liquid Extrusion Techniques for Pore Structure Evaluation of Nonwovens, International Nonwovens Journal, Vol. 12, No. 3. 2003, pp. 45-53, the complete disclosure of which is hereby incorporated herein by reference in its entirety). Porous Materials, Inc. is a pioneer in the field of porosimetry and has obtained several patents in the field, including U.S. Pat. No. 6,684,685, which describes liquid extrusion porosimetry, the complete disclosure of which is hereby incorporated herein by reference in its entirety.

In the technique of liquid extrusion porosimetry, a membrane is placed below the sample. The space in the sample chamber below the membrane is filled with the wetting liquid and is connected to a wetting liquid-filled cup, which rests on a balance. The pores of the membrane also are filled with the wetting liquid. When liquid is displaced from the pores by pressurized gas, the liquid passes through the membrane and is measured, while the gas does not pass through the membrane, as its pressure is not sufficient. The measured differential gas pressure and the weight of displaced liquid yield pore volume, pore diameter, pore volume distribution and liquid permeability. FIG. 2 shows a liquid extrusion porosimeter and sample chamber.

U.S. Pat. No. 6,684,685 discloses a liquid extrusion porosimeter and method for evaluating porosity characteristics (specifically, pore volume, pore distribution and liquid permeability) of porous materials. The porosimeter includes a fluid reservoir located below the sample and a cup that rests on a scale that catches any fluid displaced from the reservoir of fluid, wherein the weight of the liquid increases, when additional fluid enters the reservoir. The sample is wetted with the same fluid that is in the reservoir, prior to placing the sample on the porosimeter. The porosimeter preferably also includes a membrane located between the sample and the reservoir of fluid. The membrane has pores with a size smaller than any of the sample pores. Pore volume of the sample is determined by measuring the change in the weight of the fluid after pressure, which is above the bubble point pressure of the sample but below the bubble point pressure of the membrane, is applied to the sample. Permeability is measured by measuring rate of flow while excess liquid is above the sample.

Although there are known methods and apparatus that are intended to aid in the analysis of the pore structure characteristics of various porous materials, one problem with the known methods is that they are incapable of evaluating the pore size, pore volume and permeability of materials under compression. However, this is very important for a number of applications. Thus, there is a continuing need in the art for methods and apparatus suitable for accurately measuring the pore structure characteristics of materials under test conditions that include the controlled application of compression on the test sample.

### SUMMARY OF THE INVENTION

Provided herein are novel methods and apparatus for accurately measuring the pore structure characteristics of porous materials under test conditions that include the controlled application of compression on the test sample, thus overcoming the disadvantages of the prior art. The apparatus according to the invention provides a compression testing device designed for using liquid extrusion techniques to determine the pore structure characteristics of porous materials under compressive stress, including means for the controlled application of compression on the test sample. A compression testing device is operatively connected to a porometer or porosimeter to enhance its ability to determine pore structure characteristics of various porous materials under compression. Various alternative embodiments include compression testing devices for controlled application of various combinations of uniaxial, biaxial or radial, and/or triaxial compression to a sample material during porosity testing.

Briefly stated, methods and apparatus are provided for using liquid extrusion techniques for accurate pore structure characterization of materials under compression. The unique design of the apparatus permits a porous test sample to be kept under the desired compressive stress during liquid extrusion techniques, even when the size of the sample changes under compression. This arrangement also permits extrusion of liquid into the pores of the sample from all sides. In the preferred embodiment, compression testing apparatus is provided having means for controlled application of uniaxial, biaxial or radial, and/or triaxial compression to a sample material during porosity testing. The compression testing apparatus is operatively connected with a capillary flow porometer or liquid extrusion porosimeter.

In one embodiment, test apparatus for the analysis of pore structure characteristics of porous materials is provided, including a compression testing device comprising a cylindrical channel having an inner central bore, substantially solid outside, upper and lower walls, and an inner edge of the channel, which is open to the inner central bore. Flexible sealing means having an inner central bore concentric to the inner central bore of the cylindrical channel oppose the inner edge of the cylindrical channel, and the flexible inside, upper and lower walls of the flexible member overlap with and are sealingly affixed to the respective upper and lower surfaces of the cylindrical channel. The inner central bore of the flexible sealing member thus forms an inner sample chamber for the porous material to be tested. Top and bottom sealing means cover the sample chamber and a gas inlet enters through the outside wall of the cylindrical channel for applying controlled biaxial or radial compression on the test material.

In an alternative embodiment, test apparatus is provided, including a compression testing device comprising a cylindrical channel having an inner central bore, substantially solid outside, upper and lower walls, and an inner edge of the channel, which is open to the inner central bore. Flexible sealing means having an inner central bore concentric to the inner central bore of the cylindrical channel oppose the inner edge of the cylindrical channel, and the flexible inside, upper and lower walls of the flexible member overlap with and are sealingly affixed to the respective upper and lower surfaces of the cylindrical channel. The inner central bore of the flexible sealing member thus forms an inner sample chamber for the porous material to be tested. Top and bottom sealing means cover the sample chamber and a gas inlet enters through the outside wall of the cylindrical channel for applying controlled biaxial or radial compression on the test material. Means for applying triaxial compression on the sample includes a perforated rigid plate and a weight or piston sealingly engaged within the inner bore of the flexible sealing member.

In another embodiment, uniaxial compression is provided, including a compression testing device comprising a cylindrical channel having an inner central bore, substantially solid outside, upper and lower walls, and an inner edge of the channel, which is open to the inner central bore. Flexible sealing means having an inner central bore concentric to the inner central bore of the cylindrical channel oppose the inner edge of the cylindrical channel, and the flexible inside, upper and lower walls of the flexible member overlap with and are sealingly affixed to the respective upper and lower surfaces of the cylindrical channel. The inner central bore of the flexible sealing member thus forms an inner sample chamber for the porous material to be tested. Top and bottom sealing members cover the sample chamber and means for applying uniaxial compression on the sample includes a perforated rigid plate and a weight or piston sealingly engaged within the inner bore of the flexible sealing member.

In yet another embodiment, methods for measuring pore structure characteristics of a porous material are provided, including the steps of providing a compression testing apparatus in accordance with the disclosure herein, placing a test sample of a porous material in the sample chamber, sealing the top and bottom sealing means of the sample chamber, applying a measured amount of pressure on the sample, and determining one or more pore structure characteristics of the sample using a liquid extrusion technique as described herein.

The invention provides the unique advantage of enabling the analysis of pore structure characteristics of various porous materials under compressive stress, using a novel technique, which previously was unavailable. These and other features and advantages will become readily apparent from the following detailed description, which should be read in conjunction with the accompanying drawing figures.

### BRIEF DESCRIPTION OF THE DRAWING

The drawing figures are not necessarily to scale, with the emphasis instead placed upon the principles of the present invention. Additionally, each of the embodiments depicted are but one of a number of arrangements possible utilizing the fundamental concepts of the present invention. The drawings are briefly described as follows.

FIG. 1 shows a sample chamber for a capillary flow porometer.

FIG. 2 shows a liquid extrusion porosimeter and sample chamber.

FIG. 3 shows a sectional view of a compression testing device adapted for applying biaxial or radial compression on a test sample during porosity testing.

FIG. 4 shows a sectional view of a compression testing device adapted for applying biaxial or radial and/or triaxial compression on a test sample during porosity testing.

FIG. 5 shows a sectional view of a compression testing device adapted for applying uniaxial compression on a test sample during porosity testing.

FIG. 6 shows a diagram of a liquid extrusion technique.

FIG. 7 shows a pictorial view of a liquid extrusion porosimeter and compression testing apparatus according to an embodiment of the present invention.

FIG. 8 shows a graph of cumulative pore volume for a test sample.

FIG. 9 shows a graph of pore distribution for a test sample.

FIG. 10 shows measurable diameters of a through pore by liquid extrusion technique for a test sample.

FIG. 11 shows a graph of the effect of compressive stress on the pore volume of a test sample.

FIG. 12 shows a graph of the change in pore volume with square of the stress applied to a test sample.

FIG. 13 shows a graph of the decreasing influence of compressive stress on the pore volume distribution of a test sample.

### DETAILED DESCRIPTION OF THE INVENTION

The following description relates to certain preferred embodiments of an apparatus and method for using liquid extrusion techniques to determine the pore structure characteristics of porous materials, even while the porous materials are subjected to compressive stress. Numerous variations and modifications, other than those specifically indicated herein, will be readily apparent to those of sufficient skill in the art. In addition, certain terms are used throughout the discussion in order to provide a convenient frame of reference with regard to the accompanying drawings, such as “top”, “bottom”, and the like.

However, such terms are not intended to be specifically limiting of the invention, except where so indicated in the claims.

Non-woven porous materials are subjected to compressive stress during service in many applications in a broad variety of industries including biotechnology, household, healthcare, filtration, paper, and power sources. The performance of non-wovens in such applications is determined by the pore structure of the non-wovens under application environments. Therefore, determination of pore volume, pore size, and pore volume distribution of non-wovens under compressive stress is relevant. None of the currently available pore structure characterization techniques are capable of measuring such pore structure characteristics as a function of compressive stress. The inventors herein describe an innovative technology developed to measure pore volume of non-wovens as a function of desired compressive stress.

The invention provides novel technology for using liquid extrusion techniques for accurate pore structure characterization of absorbent porous materials under compressive stress, overcoming the disadvantages of the available technology currently used. The unique design permits a porous test sample to be kept under the desired compressive stress during liquid extrusion, even when the size of the sample material changes due to swelling or shrinking. Furthermore, the equipment is simple, inexpensive and almost maintenance-free.

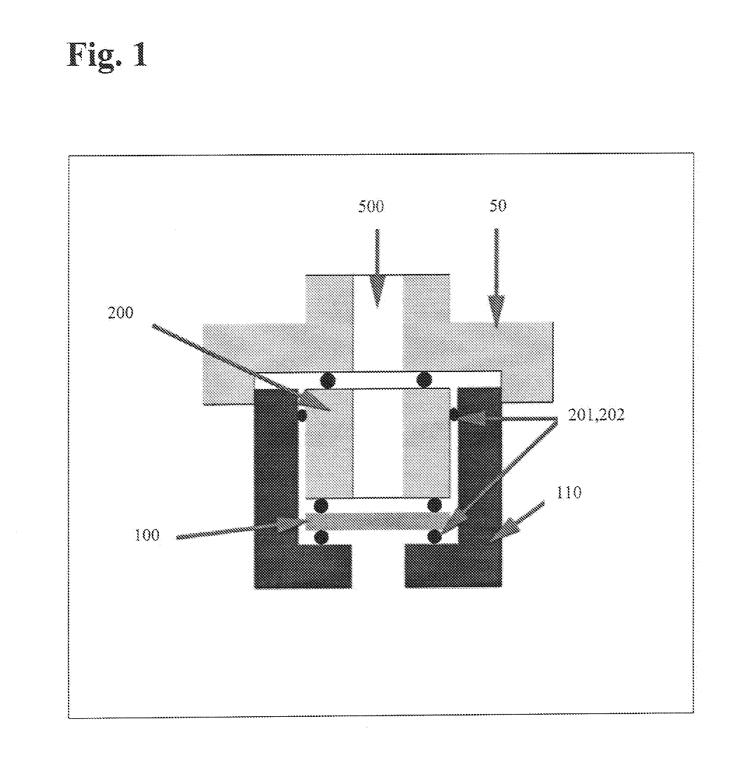

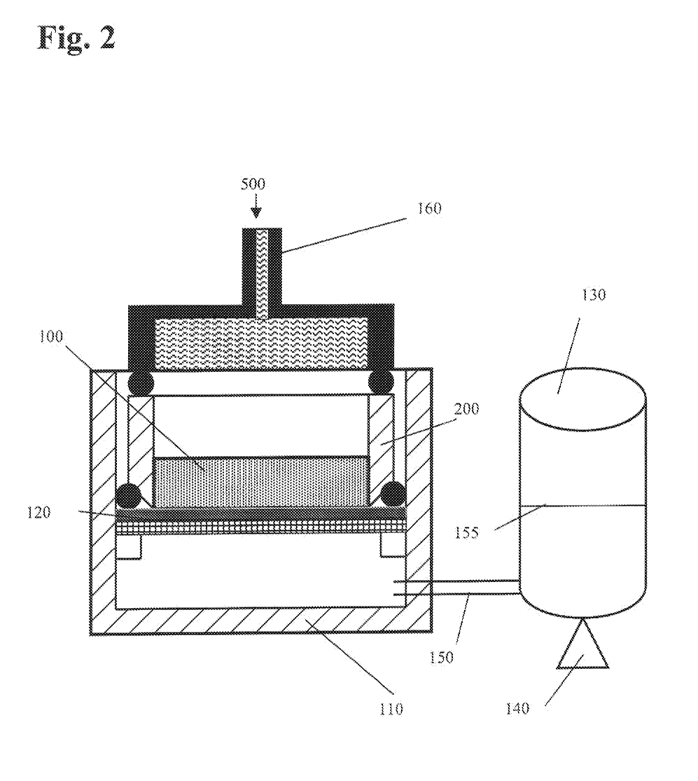

Referring to FIG. 1, a sample chamber for a capillary flow porometer is shown. The sample chamber 110 has a closure 50, such as a screw-on lid, preferably having an O-ring seal, and in inlet for entry of a compressed test gas 500. The porous material test sample is held by a test insert 200 sealed within the sample chamber 110. Additional O-rings 201, 202 create a seal between the insert 200 and the sample chamber 110 and the sample 100. FIG. 2 depicts a sample chamber operatively connected to a liquid extrusion porosimeter. The test sample 100 is placed in the insert 200, which is then sealed in the sample chamber 110, which extends below the membrane 120 and is connected to a container 130 supported on a weighing balance 140. The volume of the sample chamber 110 below the membrane, the container 130, and the tube 150 connecting the sample chamber to the container are filled with wetting liquid without leaving any air gap between the liquid and the sample (see liquid level 155, FIG. 2). A pressurized test gas inlet 160 allows the application of a selected test gas pressure to the sealed sample chamber. The wetting liquid displaced from the pores of the sample and flowing out of the pores of the membrane flows into the container and is measured by the balance.

### Example

### Effect of Compressive Stress on Pore Volume of Non-Wovens

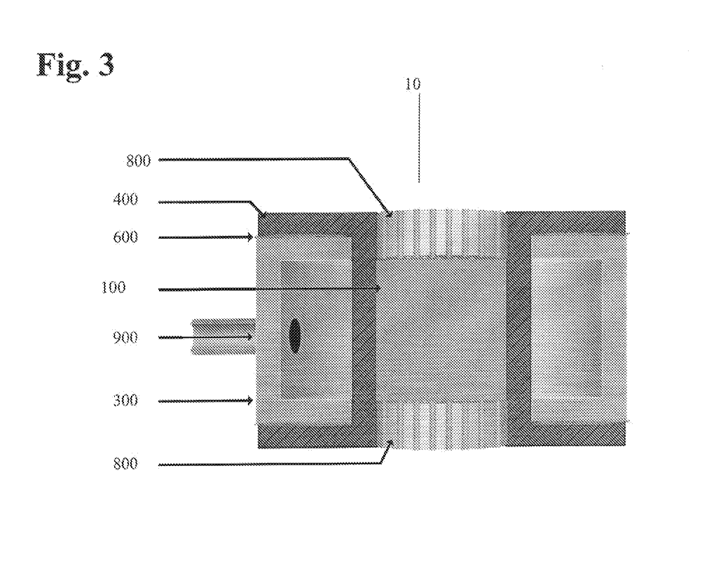

As an example demonstrating the utility of present invention, the pore volume and pore volume distribution as a function of imposed compressive stress on a non-woven porous material was analyzed in detail and the test results are herein disclosed to illustrate the application of the novel techniques. FIG. 2 shows a liquid extrusion porosimeter operatively connected to a sample chamber and FIGS. 3-5 show sectional views of various compression testing inserts adapted for applying biaxial or radial compression, triaxial compression and uniaxial compression on a test sample during porosity testing. The compression testing inserts confine the test samples under suitable conditions, such that the desired pressure can be applied on the sample, while the test is being performed. These compression testing inserts are loaded into the sample chamber for performing the tests.

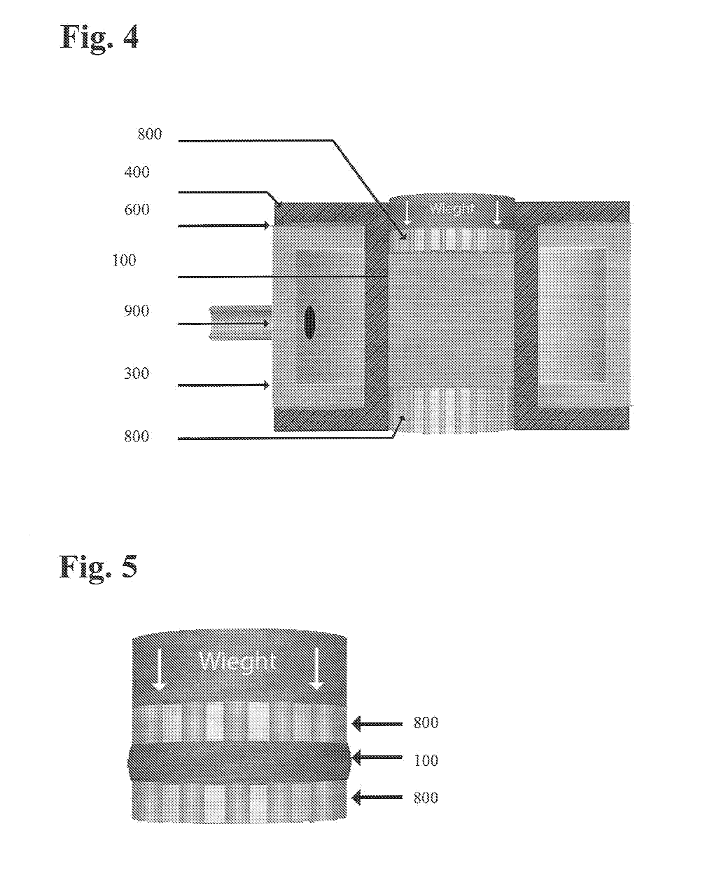

FIG. 3 illustrates insert apparatus used for application of biaxial or radial compression and demonstrates how the test sample is kept under the desired compressive stress, while the tests are being conducted. The test insert 10 comprises a cylindrical channel 300 (preferably of metal) having an inner central bore, substantially solid outside, upper and lower walls, and an inner edge of the channel, which is open to the inner central bore. Flexible sealing means 400 (preferably of rubber) having an inner central bore concentric to the inner central bore of the cylindrical channel oppose the inner edge of the cylindrical channel, and the flexible inside, upper and lower walls of the flexible member 400 overlap with and are sealingly affixed with an adhesive layer 600 to the respective upper and lower surfaces of the cylindrical channel 300. The inner central bore of the flexible sealing member thus forms an inner sample chamber for holding the porous material 100 to be tested. Top and bottom sealing members seal the sample chamber and a gas inlet 900 (FIG. 4) enters through the outside wall of the cylindrical channel 300 for applying controlled biaxial or radial compression on the test material via a pressurized gas. Controlled gas pressure maintains the sample under the desired stress, even when the sample size changes during the test.

FIG. 4 illustrates apparatus used for application of triaxial compression. In addition to applying compression radially, the sample is compressed in the z-direction as well. Controlling the weight and gas pressure, one can apply any desired stress to a sample during testing. FIG. 5 illustrates additional apparatus for applying uniaxial compression. In this embodiment, any desired weight can be used. Optionally, other suitable means for applying uniaxial compression on the sample includes a perforated rigid plate and a piston.

Basic Principles: Displacement of Wetting Liquid from a Pore—

For a more detailed explanation of the basic principles involved, see Akshaya Jena and Krishna Gupta, Characterization of Pore Structure of Filtration Media, Fluid Particle Separation Journal, Vol. 4, No. 3, 2002, pp. 227-241; Akshaya Jena and Krishna Gupta, Liquid Extrusion Technique for Pore Volume Evaluation of Nonwovens, International Nonwovens Journal, Fall, 2003, pp. 45-53; Vibhor Gupta and Akshaya Jena, Substitution of Alcohol in Porometers for Bubble Point Determination, Advances in Filtration and Separation Technology, AFSS, Vol. 13b, 1999, pp. 833-844. Generally, a liquid that can spontaneously flow in to pores of a sample is known as the wetting liquid. The process is spontaneous because the solid/wetting liquid interfacial free energy is less than the solid/gas interfacial free energy and filling of the pores of the sample with the wetting liquid reduces the free energy of the system. The reverse process is not spontaneous because removal of the wetting liquid from the pore by a gas replaces solid/liquid interface by solid/gas interface and increases the free energy. For displacement of the wetting liquid from a pore by the gas, the work done by the gas must be equal to the increase in the interfacial free energy. Differential pressure, p, is related to the pore diameter, D as follows:

p=(dSs/g/dV)γl/g cos θ (2)

where γl/g is gas/liquid interfacial free energy, θ is contact angle, dV is infinitesimal increase in the volume of the gas in the pore, and dSs/g is infinitesimal increase of the solid/gas interfacial area. The diameter of a pore at any cross-section perpendicular to the direction of gas flow is defined as the diameter of a cylindrical opening such that:

[dS/dV](pore)=[dS/dV](cylindrical opening of diameter, D)=[4/D] (3)

Consequently:

p=[4γl/g Cos θ]/D (4)

Test Method—

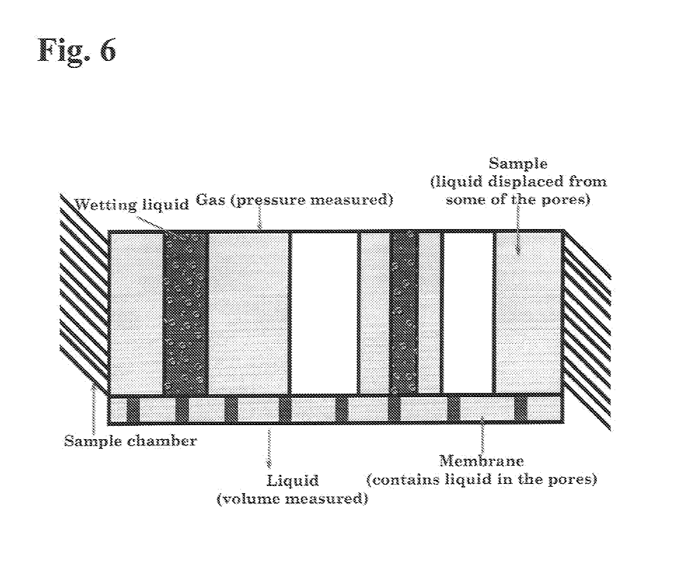

The sample is placed on a membrane whose largest pore is smaller than the smallest pore of interest in the sample. The pores of the sample and the membrane are filled with a wetting liquid. When pressurized gas displaces liquid from the pores of the sample the displaced liquid flows out through the liquid filled pores of the membrane. Gas pressure adequate to displace the wetting liquid from the pores of interest in the sample is inadequate to displace the wetting liquid from the small pores of the membrane. During the test the pores of the membrane remain filled with liquid and prevent passage of gas to the sample chamber below the membrane (FIG. 6). The volume of liquid flowing out of the membrane is the volume of pores; differential pressure yields pore diameter.

Technique: Measurement of Displaced Liquid and Pressure—

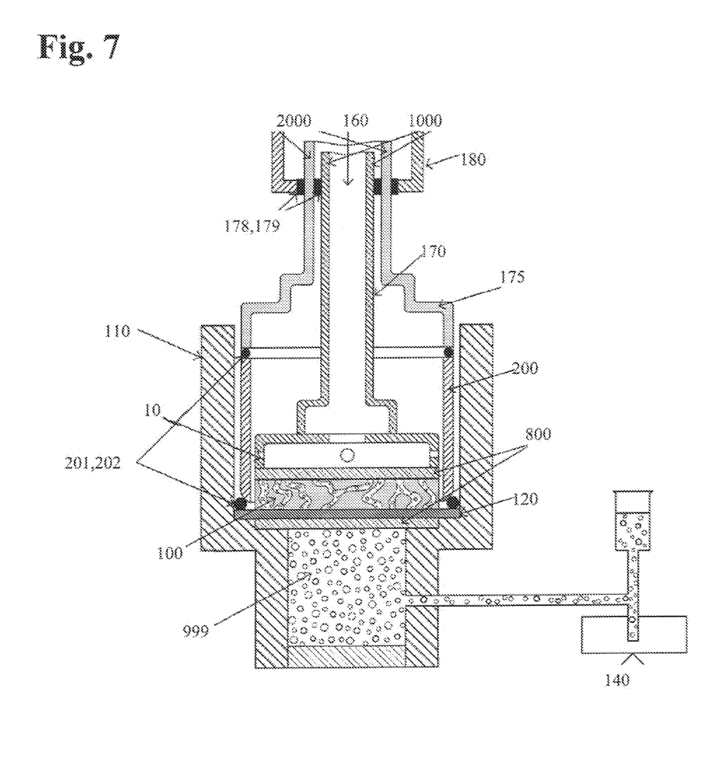

The test apparatus is shown in FIG. 7. The test sample 100 is placed in the sample chamber 110, which extends below the membrane 120 and is connected to a container supported on a weighing balance 140. The area of the sample chamber below the membrane, the container and the tube 150 connecting the sample chamber to the container are filled with wetting liquid 999 without leaving any air gap between the liquid and the sample (see liquid level 155, FIG. 2). A pressurized test gas inlet 160 allows the application of a selected test gas pressure to the sealed sample chamber. The wetting liquid displaced from the pores of the sample and flowing out of the pores of the membrane flows into the container and is measured by the balance. The differential gas pressure of the test gas is measured by pressure transducers.

Compressive Stress on Sample—

A smaller inner piston rod 170 enters the sample chamber through an outer hollow piston rod 175, both piston rods entering the sample chamber through seals 178, 179. Pressure on the inner piston rod 170 is computer controlled using a pneumatic piston-cylinder device 180. The sample is placed between two highly porous rigid discs 800 and the inner piston rod 170 compresses the piston on the sample by applying pressure on the discs 800. The inner piston rod 170 is also hollow, allowing the test gas 500 to enter the sample chamber through inlet 160. Openings at the bottom of the piston rod permit the gas to distribute itself. Net compressive stress on the sample is computed by subtracting the upward force due to test pressure from the downward force applied by the inner piston rod.

Sealing of Sample Chamber—

The outer piston rod 175 compresses test insert 200, which applies uniform controlled pressure on the O-rings 201, 202 at the top and bottom of the sample chamber to seal the membrane and prevent gas leak around the membrane 120. The O-ring 201 between the piston rod and the insert seals the sample chamber. Pressure on the outer piston rod 175 is computer controlled using the pneumatic piston-cylinder device 180. However, pressure controls 1000, 2000 on the inner and outer piston rods are completely independent of each other.

Test Procedure—

The cup on the balance is filled with the wetting liquid until the liquid level is just above the membrane in the sample chamber. The sample with its pores filled with the wetting liquid is placed on the membrane. Inner piston is brought down on the sample and the desired stress is applied. The outer piston is brought down to seal the sample and the chamber. The test gas is introduced. Gas pressure and weight of liquid on the balance are recorded as a function of increasing pressure. Once the test is done, the test gas pressure is reduced to zero, sample is rewetted in the sample chamber, compressive stress on the sample is increased, and the test is again executed.

Through Pore Volume—

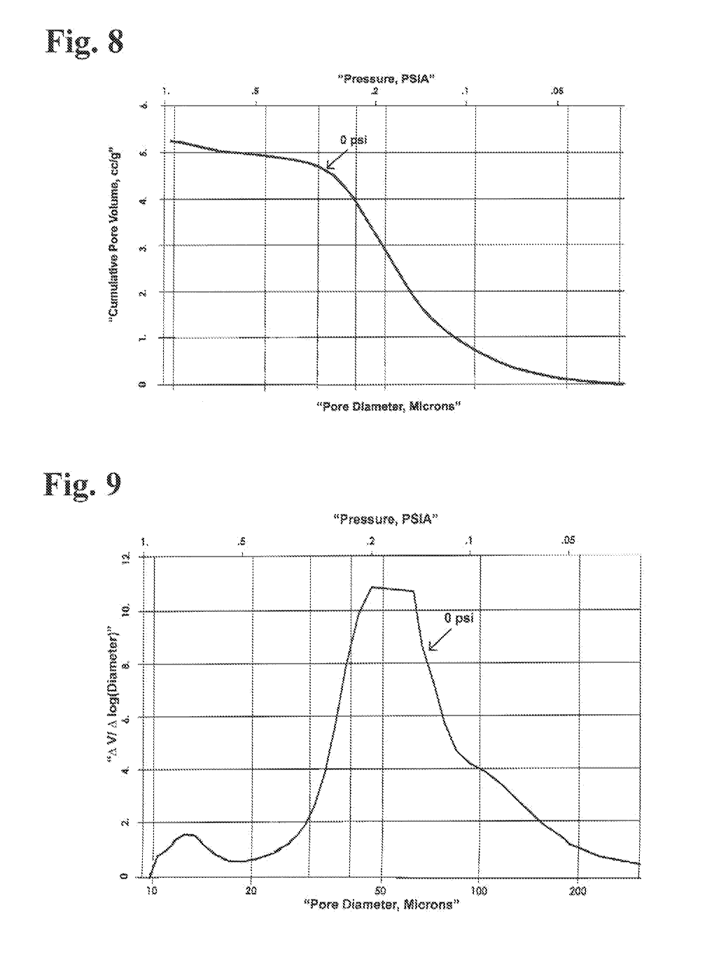

The measured volume of extruded liquid is the through pore volume. Cumulative through pore volume measured as a function of pore diameter of sample without any compressive stress is presented in FIG. 8. As the pressure is increased, liquid is extruded from smaller pores and the cumulative pore volume increases. When liquid from all the pores have been removed, increase of pressure does not extrude any more liquid and cumulative pore volume does not increase.

Through Pore Distribution—

Distribution of pore volume over pore diameter is given by the distribution function fv:

fv=−[dV/d log D] (5)

where V is the cumulative pore volume. Integration of this function shows that:

∫dV=−∫fvd log D (6)

Thus, volume of pores in any pore diameter range is obtained from the area under the plot of fv against log D. The typical variation distribution function is shown in FIG. 9.

Through Pore Diameters—

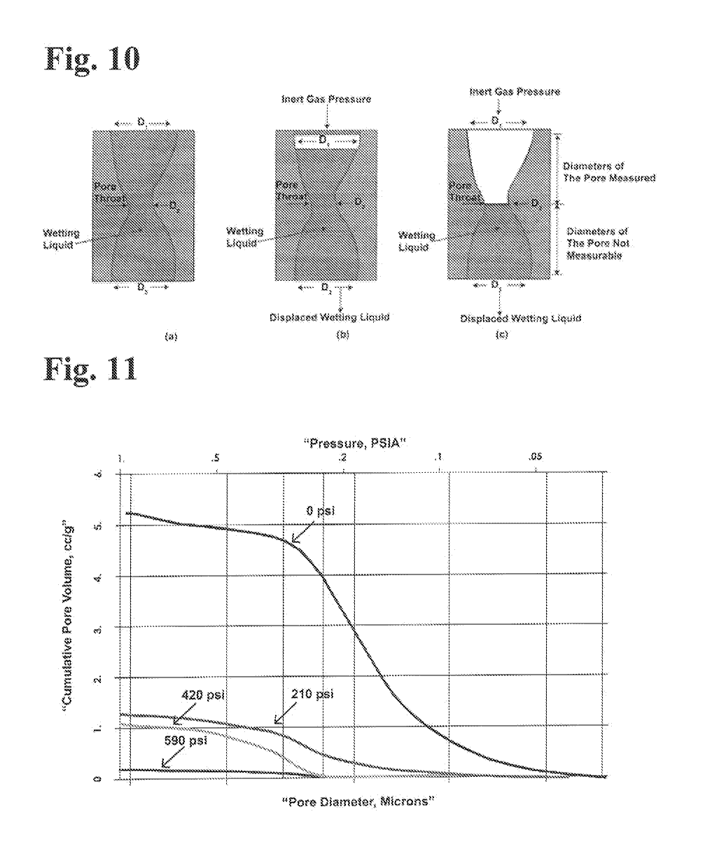

As the pressure is increased on the sample, liquid is first displaced from the mouth of a pore and then from the narrower parts until the pore throat. All diameters of a pore from its mouth to its throat are measured. The pressure required to displace liquid from the throat completely displaces liquid from the pore beyond the throat without further increase in pressure. Therefore, diameters of a pore from the throat to the exit are not measured (FIG. 10).

Effect of Compressive Stress on Pore Volume—

Appreciable influence of three different levels of compressive stress, 210, 420, and 590 psi on pore volume is demonstrated in FIG. 11. The data in Table 1 show that influence of compressive stress on pore volume is large in the beginning and decreases with increasing stress. The empty spaces between the fibers are eliminated in the beginning. As the fibers get squeezed, it becomes more difficult to remove pores.

TABLE 1
Effect of compressive stress on sample on the pore volume

| Stress, psi | Pore Volume, cc/g | Relative Value |
|---|---|---|
| 0 | 5.3153 | 100% |
| 210 | 1.2812 | 24.1% |
| 420 | 1.0859 | 20.4% |
| 590 | 0.1874 | 3.5% |

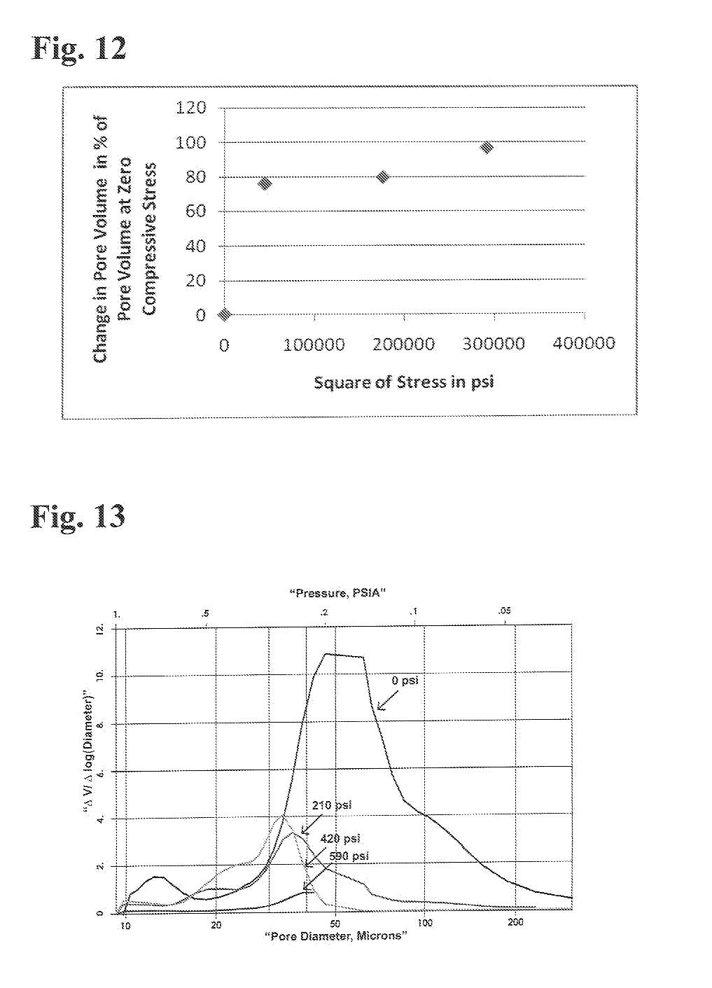

It can be shown that change in pore volume is proportional to square of stress. See Vibhor Gupta and Akshaya Jena, Effect of Compression on Porosity of Filter Materials, Advances in Filtration and Separation Technology, AFSS, Vol. 13a, 1999, pp. 10-17. It is clear from FIG. 12 that after the initial elimination of voids, the change in pore volume increases linearly with square of stress.

Effect of Compressive Stress on Pore Volume Distribution—

The influence of compressive stress on pore volume distribution is shown in FIG. 13. The area under each curve is the total pore volume. With increasing compressive stress, the total pore volume decreases, the pore diameters become smaller, and very small pores become undetectable because of their reduced volume. The effect is appreciable in the beginning and decreases with increase in compressive stress.

Additional Capability—

The technique is versatile. In this study, the effects of compressive stress on pore volume were measured at room temperature. However, using the same equipment the effects of compressive stress on pore structure can be measured at elevated temperatures up to 200° C. using many chemicals, and under controlled humidity.

### CONCLUSION

The pore volume and pore diameter of a nonwoven under compressive stresses was measured using liquid extrusion porosimetry. The basic principles of the method, the technique, and data analysis for obtaining the pore structure characteristics were considered. The results obtained using 0 psi, 210 psi, 420 psi and 590 psi compressive stresses on the sample were presented. Compressive stress decreases the pore volume and pore diameter. The small pores are almost completely eliminated. The influence of the stress is large in the beginning and decreases rapidly with increasing stress.

The present invention thus provides the advantage of enabling the rapid and more accurate characterization of pore structure characteristics in the bulk material as well as in the x-y plane, and the effects of compressive stress on the pores of a variety of materials. Furthermore, the invention provides means for measuring the effects of compressive stress on pore volume, pore diameter and pore distribution. The invention has numerous applications in the development, manufacture and analysis of porous materials that are widely used in many industries, including the pharmaceutical industry, healthcare industry, fiber and clothing industry, and filtration media industry, as well as many others.

It is to be understood that the architectural and operational embodiments described herein are exemplary of a plurality of possible arrangements to provide the same (or equivalent) general features, characteristics, and general system operation. Therefore, while there have been described the currently preferred embodiments of the present invention, those skilled in the art will recognize that other and further modifications may be made, without departing from the spirit of the present invention, and it is intended to claim all modifications and variations as fall within the scope of the appended claims. Accordingly, it must further be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. Test apparatus for measuring pore structure characteristics of a porous material, comprising:
a compression testing device having means for controlled application of compression on a sample of said porous material;
wherein said compression testing device is operatively connected with a capillary flow porometer or liquid extrusion porosimeter.

2. The apparatus of claim 1, wherein said compression testing device comprises:
a) a cylindrical channel having an inner central bore, said channel having substantially solid upper and lower walls and an outside wall, wherein an inner edge of said channel is open to said inner central bore;
b) flexible sealing means having an inner central bore concentric to said inner central bore of said cylindrical channel, said sealing means opposing said inner edge of said cylindrical channel;
c) said flexible sealing means having inside, upper and lower walls, wherein said inside wall opposes said inner edge of said channel, and said upper and lower walls of said flexible sealing means overlap with and are sealingly affixed to respective upper and lower surfaces of said solid upper and lower walls of said cylindrical channel;
d) said inner central bore of said flexible sealing means forming an inner sample chamber for said porous material;
e) top and bottom sealing members for sealing said inner sample chamber; and
f) gas inlet means entering said outside wall of said cylindrical channel for applying controlled biaxial or radial compression on said porous material.

3. The apparatus of claim 2, wherein a predetermined or continuous amount of compression is applied to said sample during testing.

4. The apparatus of claim 2, further comprising means for applying triaxial compression to said sample.

5. The apparatus of claim 4, wherein said means for applying triaxial compression comprises a perforated rigid plate and a weight or piston sealingly engaged within the inner bore of said flexible sealing member.

6. The apparatus of claim 5, wherein said compression means comprises a rod operably connected at a first end thereof to said perforated rigid plate, said rod passing through a pressure-tight seal into said sample chamber.

7. The apparatus of claim 6, wherein said rod is connected at a second end thereof to a piston-cylinder device for applying controlled compressive stress on said sample.

8. The apparatus of claim 7, wherein said piston-cylinder device is pneumatically operated.

9. The apparatus of claim 1, wherein said compression testing device comprises:
a) a cylinder of substantially solid material having an inner central bore;
b) said inner central bore of said cylinder forming an inner sample chamber for said porous material;
c) top and bottom sealing members for sealing said inner sample chamber; and
d) means for applying controlled uniaxial compression on said porous material.

10. The apparatus of claim 9, wherein a predetermined or continuous amount of compression is applied to said sample during testing.

11. The apparatus of claim 10, wherein said means for applying compression comprises a perforated rigid plate and a weight or piston sealingly engaged within the inner bore of said sample chamber.

12. The apparatus of claim 11, wherein said compression means comprises a rod operably connected at a first end thereof to said perforated rigid plate, said rod passing through a pressure-tight seal into said sample chamber.

13. The apparatus of claim 12, wherein said rod is connected at a second end thereof to a piston-cylinder device for applying controlled compressive stress on said sample.

14. The apparatus of claim 13, wherein said piston-cylinder device is pneumatically operated.

15. A method for measuring pore structure characteristics of a porous material, comprising the steps of:
a) providing an apparatus according to claim 2;
b) placing a test sample of a porous material in said sample chamber;
c) sealing said top and bottom sealing means of said sample chamber;
d) applying a measured amount of pressure on said sample; and
e) determining one or more pore structure characteristics of said sample using a liquid extrusion technique.

16. The method of claim 15, wherein one or more pore structure characteristics is computed using the equation P=4γ cos θ/D.

17. A method for measuring pore structure characteristics of a porous material, comprising the steps of:
a) providing an apparatus according to claim 5;
b) placing a test sample of a porous material in said sample chamber;
c) sealing said top and bottom sealing means of said sample chamber;
d) applying a measured amount of pressure on said sample; and
e) determining one or more pore structure characteristics of said sample using a liquid extrusion technique.

18. The method of claim 17, wherein one or more pore structure characteristics is computed using the equation P=4γ cos θ/D.

19. A method for measuring pore structure characteristics of a porous material, comprising the steps of:
a) providing an apparatus according to claim 9;
b) placing a test sample of a porous material in said sample chamber;
c) sealing said top and bottom sealing means of said sample chamber;
d) applying a measured amount of pressure on said sample; and
e) determining one or more pore structure characteristics of said sample using a liquid extrusion technique.

20. The method of claim 19, wherein one or more pore structure characteristics is computed using the equation P=4γ cos θ/D.
